(19) United States
(12) Patent Application Publication
(10) Pub. No.: US 2026/0212242 A1
(43) Pub. Date: Jul. 23, 2026

(54) PARAMETER-SETTING METHOD, SYSTEM, AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Yuxing CHEN, Shenzhen (CN); Gongsheng YUAN, Shenzhen (CN); Liyuan JIA, Shenzhen (CN); Anqun PAN, Shenzhen (CN)

(73) Assignee: TENCENT TECHNOLOGY (SHENZHEN) COMPANY LIMITED, Shenzhen (CN)

(21) Appl. No.: 19/569,011

(22) Filed: Mar. 17, 2026

Related U.S. Application Data
(63) Continuation of application No. PCT/CN2024/126536, filed on Oct. 22, 2024.

(30) Foreign Application Priority Data
Nov. 8, 2023 (CN) 202311482543.7

(51) Int. Cl. G06N 10/20

(52) U.S. Cl. CPC G06N 10/20

(57) ABSTRACT

A parameter setting method, apparatus, and computer-readable storage medium for optimizing database parameters using quantum algorithms. The method obtains parameter value ranges and an objective function measuring database performance metrics. A Traveling Salesman Problem model is constructed where paths represent parameter value combinations and path lengths correspond to the objective function. A quantum algorithm model is constructed based on the TSP model and used to solve for the optimal solution. Database parameters are then set according to the parameter value combination corresponding to this optimal solution, enabling efficient database optimization through quantum computing approaches to combinatorial optimization problems.

### CROSS-REFERENCE TO RELATED APPLICATION

This application is a continuation application of International Application No. PCT/CN 2024/126536 filed on Oct. 22, 2024 which claims priority to Chinese Patent Application No. 202311482543.7, filed with the China National Intellectual Property Administration on Nov. 8, 2023, the disclosures of each being incorporated by reference herein in their entireties.

### FIELD

The disclosure relates to the technical field of database systems, a parameter setting method, system, and apparatus, a device, a storage medium, and a program product.

### BACKGROUND

Selecting an optimal parameter configuration is an important problem in a database system.

In the related art, a parameter tuning problem of a database may be usually solved based on experience and trial and error. Current parameter tuning research primarily focuses on aspects such as automatic tuning, statistics-based tuning, machine learning-based tuning, and deep learning-based tuning.

However, due to enormous parameters of the database system, the tuning solution in the related technology may need to consume a large amount of time and resources, which results in relatively low efficiency of parameter tuning of the database.

### SUMMARY

Provided are a parameter setting method and apparatus, a device, a storage medium, and a program product, which can implement efficient database parameter optimization through quantum algorithm-based solution of Traveling Salesman Problem models.

According to some embodiments, a parameter setting method, performed by a computer device, includes: obtaining parameter value ranges of a plurality of parameters of a database and an objective function to measure a performance metric of the database; constructing a Traveling Salesman Problem (TSP) model based on the parameter value ranges and the objective function, wherein a path in the TSP model is a parameter value combination of the plurality of parameters and a path length in the TSP model is the objective function; constructing a quantum algorithm model based on the TSP model; solving an optimal solution of the TSP model based on the quantum algorithm model; and setting the plurality of parameters based on a parameter value combination corresponding to the optimal solution of the TSP model.

According to some embodiments, a parameter setting apparatus, includes: at least one memory configured to store program code; and at least one processor configured to read the program code and operate as instructed by the program code, the program code including: obtaining code configured to cause at least one of the at least one processor to obtain parameter value ranges of a plurality of parameters of a database and an objective function to measure a performance metric of the database; TSP code configured to cause at least one of the at least one processor to construct a Traveling Salesman Problem (TSP) model based on the parameter value ranges and the objective function, wherein a path in the TSP model is a parameter value combination of the plurality of parameters and a path length in the TSP model is the objective function; quantum code configured to cause at least one of the at least one processor to construct a quantum algorithm model based on the TSP model; solving code configured to cause at least one of the at least one processor to solve an optimal solution of the TSP model based on the quantum algorithm model; and setting code configured to cause at least one of the at least one processor to set the plurality of parameters based on a parameter value combination corresponding to the optimal solution of the TSP model.

According to some embodiments, a non-transitory computer-readable storage medium, storing computer code which, when executed by at least one processor, causes the at least one processor to at least: obtain parameter value ranges of a plurality of parameters of a database and an objective function to measure a performance metric of the database; construct a Traveling Salesman Problem (TSP) model based on the parameter value ranges and the objective function, wherein a path in the TSP model is a parameter value combination of the plurality of parameters and a path length in the TSP model is the objective function; construct a quantum algorithm model based on the TSP model; solve an optimal solution of the TSP model based on the quantum algorithm model; and set the plurality of parameters based on a parameter value combination corresponding to the optimal solution of the TSP model.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of an architecture of a distributed database according to some embodiments.

FIG. 2 is a schematic diagram of an application scenario of a solution according to some embodiments.

FIG. 3 is a flowchart of a parameter setting method according to some embodiments.

FIG. 4 is a flowchart of a parameter setting method according to some embodiments.

FIG. 5 is a flowchart of a parameter setting method according to some embodiments.

FIG. 6 is a flowchart of a parameter setting method according to some embodiments.

FIG. 7 is a flowchart of a parameter setting method according to some embodiments.

FIG. 8 is a flowchart of solving a parameter tuning problem based on a classical computer according to some embodiments.

FIG. 9 is a flowchart of solving a parameter tuning problem based on a quantum computer according to some embodiments.

FIG. 10 is a flowchart of a parameter selection method according to some embodiments.

FIG. 11 is a block diagram of a parameter setting apparatus according to some embodiments.

FIG. 12 is a structural block diagram of a computer device according to some embodiments.

FIG. 13 is a schematic diagram of a parameter setting system according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The following describes a definition of some terms used in this application.

Database (DB): it is an organic collection of a large amount of data that is organized in a structure, stored in a computer for a long time, and can be shared. Each database has one or more different application programming interfaces (APIs) configured to create, access, manage, search for, and copy stored data.

Quantum computing: it is a computing method that completes computational tasks quickly based on quantum logic and properties of quantum states, such as superposition and entanglement. A unit for storing data in quantum computing is a qubit.

Qubit: it is a carrier form of quantum information, and is also a unit in quantum computing. A classical computer uses 0 and 1 as units of a binary system. A difference lies in that quantum computing may process 0 and 1 simultaneously, and a system may be in a linear superposition state of 0 and 1:|ψ>=α|0>+β|1>, where α and β represent complex probability amplitudes of the system at 0 and 1. Squared modulus |α|²∧|β|² of α and β respectively represent probabilities of the qubit at 0 and 1. Quantum operation: it refers to performing a manipulation on a qubit, to

process quantum information carried in the qubit. Common quantum operations include Pauli X, Y, and Z transforms (or written as σₓ, σ_{y}, and σ_{z}), a Hadamard transform (H), a

### Controlled Pauli X Transform, Namely, a Controlled-not (cnot) Gate, and the Like.

Quantum circuit: it is a description model of quantum computing, is formed by

a qubit and a quantum operation on the qubit, and represents a hardware implementation of a corresponding quantum algorithm/program in a quantum gate model. The quantum circuit is formed by a sequence of a series of quantum gates and performs computations through the quantum gates. If the quantum circuit includes an adjustable parameter for controlling the quantum gate, the quantum circuit is referred to as a parameterized quantum circuit.

Quantum computing device: it is a physical apparatus that performs quantum computing.

Traveling Salesman Problem (TSP): it is a classic combinatorial optimization problem. A classic TSP may be described as follows: one commodity salesman may market commodities to several cities, and the salesman starts from one city, and may return to a starting place after passing through all cities. How to choose a travel route to minimize a total travel distance. From the perspective of graph theory, the problem is essentially searching for a Hamiltonian cycle with a smallest weight in a weighted completely undirected graph. Because feasible solutions to the problem are all permutations of all vertices, a combinatorial explosion occurs as a quantity of vertices increases. Therefore, the TSP is a nondeterministic polynomial (NP)-complete problem.

Hamiltonian cycle: it is set that G=(V, E) is a graph, and if a path in G passes through each vertex just once, the path is referred to as a Hamiltonian path. If one cycle in G passes through each vertex just once, the loop is referred to as a Hamiltonian cycle. If a Hamiltonian cycle exists in a graph, the graph is referred to as a Hamiltonian graph.

NP problem: an NP problem is the class of all decision problems that are solvable in nondeterministic polynomial time.

Grover's algorithm: it is also referred to as a quantum search algorithm, refers to a non-structured search algorithm running on a quantum computer, and is one of algorithms of quantum computing.

Distributed database (DDB): it is a physically dispersed but logically centralized database system, and is a product of combining a database technology and a computer network. The DDB includes a compute layer, a storage layer, and a metadata layer. The compute layer is configured to perform a permission check on data access, route access, and the like. The storage layer is configured to store data. The metadata layer is configured to store metadata information. When started, the compute layer of the distributed database obtains all cluster information by accessing the metadata layer. This is essential for properly handling tasks such as Structured Query Language (SQL) parsing and routing.

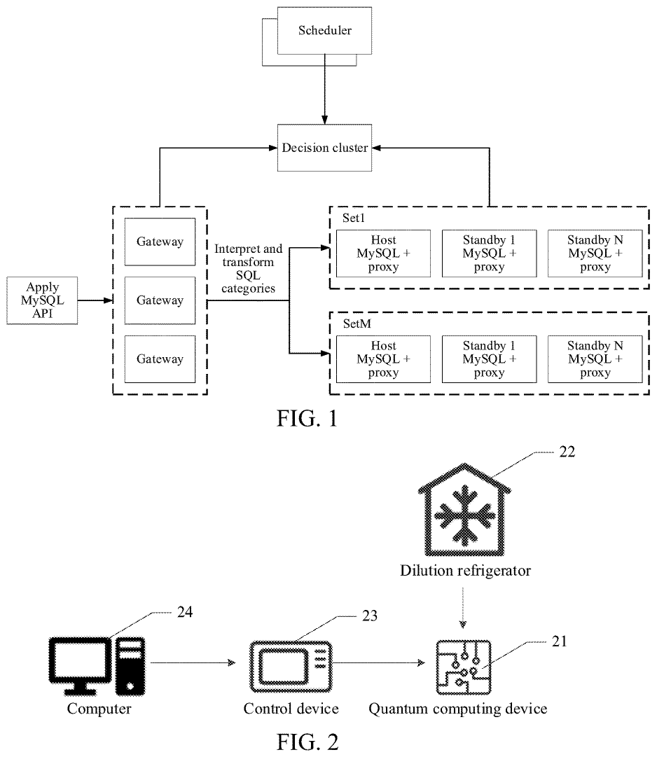

FIG. 1 shows a diagram of an architecture of a distributed database according to some embodiments. As shown in FIG. 1, the distributed database includes a scheduler, a ZooKeeper (ZK) cluster, a gateway, and a set.

Scheduler: 1. retrieve a Data Definition Language (DDL) task from ZK, and execute the DDL task on an actual MySQL instance; 2. obtain a task from ZK, and generate a scaling task; 3. control host-standby switching in the Set; and 4. achieve fault tolerance among a plurality of Schedulers through election implemented via ZK.

Gateway: 1. identify a DDL operation, and save the DDL operation to the ZK cluster in a form of a task; 2. identify a Data Manipulation Language (DML) operation, perform SQL transform, and transmit the transformed operation to a host or a standby in a corresponding Set; 3. collect responses from nodes in the Set, and return the responses to an API of a front-end application after combination; and 4. check the ZK cluster, and retrieve information such as a route and permission.

Set: 1. check an instance state and report the instance state to ZK; 2. check a state of a table and report the state to ZK; 3. retrieve a migration task from ZK and execute the migration task; and 4. participate in a host-standby switching process.

DDL: it is configured for creating or deleting an object such as a database configured to store data and a table in the database.

DML: it is configured for querying or changing a record in a table.

ZK cluster: its primary functions are configuration maintenance, election decision, route synchronization, and the like; and meanwhile, it can assist in storing information such as routing, control information, task information, and heartbeat.

Parameter tuning is an important problem in a database system, and relates to how to select an optimal parameter configuration, to enhance performance and reliability of the database system. Parameters in the database system include a buffer size, a thread pool size, a log size, lock granularity, and the like. Different parameter configurations may have different impacts on performance and reliability of the database system. Therefore, selecting the optimal parameter configuration is crucial to the performance and reliability of the database system.

A parameter tuning method is based on experience and trial and error, and requires a large amount of manual intervention and experiments. This method has low efficiency, and it is very difficult to find the optimal parameter configuration. Therefore, how to automatically select the optimal parameter configuration has become one of hotspots in database system research.

Current parameter tuning research primarily focuses on aspects such as automatic tuning, statistics-based tuning, machine learning-based tuning, and deep learning-based tuning. These research results can help database administrators and developers select the optimal parameter configuration, to enhance performance and reliability of the database system.

Researchers hope to obtain a quantum advantage in complex computations. Therefore, quantum computing has attracted wide attention in many research fields. Although quantum computing has been researched for dozens of years, in recent years, accelerated development of quantum computing hardware has resulted in increasing interest of researchers in quantum computing. In addition, cloud-based access to quantum systems makes quantum computing more feasible for researchers, which allows the first batches of experiments to be conducted on real quantum processing units (QPUs).

Different from central processing units (CPUs), QPUs use a quantum bit or a qubit for computation. The QPUs have larger mathematical states that are exponentially larger than those of classical bits and can realize a phenomenon such as quantum superposition, quantum entanglement, or quantum interference. It is widely considered that, in view of accepted assumptions of complexity theory, a quantum system provides a higher computing capability than a classical system. A plurality of quantum algorithms have been proven to have an acceleration effect, and some seminal experiments have proven a quantum advantage over real hardware.

In addition, quantum computing excels at solving an optimization problem that requires identification of an element with a property within a (exponentially large) search space. This problem is very common in database systems, and particularly, is closely related to database query optimization.

Therefore, exploring application of quantum cloud services (QCs) to database query optimization is a challenging and promising research direction.

In a database optimization problem, a parameter tuning problem is an important problem. A computer may consume a large amount of time and resources to solve this problem. Parameter tuning is essentially an NP-hard problem due to a huge parameter space. Therefore, a fast and efficient method is to solve this problem.

Appearance of quantum computers provides a new opportunity for solving the parameter tuning problem. The quantum computer is a computer based on principles of quantum mechanics, and can solve some problems more quickly than a classical computer in some cases. Quantum machine learning is a method for accelerating machine learning through a quantum computer. In parameter tuning and optimization, quantum machine learning can accelerate an optimization process through technologies such as a quantum support vector machine (QSVM) and a parameterized quantum circuit (PQC).

FIG. 2 shows a schematic diagram of an application scenario of a solution according to some embodiments. As shown in FIG. 2, the application scenario may be a superconducting quantum computing platform. The application scenario includes: a quantum computing device 21, a dilution refrigerator 22, a control device 23, and a computer 24.

The quantum computing device 21 is a circuit that acts on a physical qubit. The quantum computing device 21 may be implemented as a quantum chip such as a superconducting quantum chip operating near absolute zero. The dilution refrigerator 22 is configured to provide an absolute zero environment for the superconducting quantum chip.

The control device 23 is configured to control the quantum computing device 21. The computer 24 is configured to control the control device 23. For example, a written quantum program is compiled into instructions by using software on the computer 24, and the instructions are transmitted to the control device 23 (such as an electronic/microwave control system). The control device 23 converts the foregoing instructions into electronic/microwave control signals and inputs the signals to the dilution refrigerator 22 to control a superconducting qubit at a temperature less than 10 mK. A reading process is the opposite. A read waveform is transmitted to the quantum computing device 21.

Before method embodiments are described, an operating environment of the method is described. The method provided in some embodiments may be performed in a hybrid device environment of a classical computer and a quantum computer.

The classical computer refers to a computer that uses a binary system to store and process information via bits. Although a computing capability of the classical computer is continuously enhanced with development of hardware, a computing speed of the classical computer is still physically limited, and it is difficult to reach a theoretical optimal solution in some problems. For example, an NP-complete problem can only be solved by using an exhaustive method on the classical computer, which results in very high time complexity.

The quantum computer refers to a computer that stores and processes information via qubits. Different from bits in the classical computer, which can only be a state of 0 or 1, and the qubits have features of a quantum superposition state and quantum entanglement, which enables the quantum computer to have a more powerful computing capability compared with a computer.

In the following method embodiments, for ease of description, a description is made by only using a computer device as an execution body of operations. The computer device may include a hybrid execution environment of a classical computer and a quantum computer. This is not limited in some embodiments.

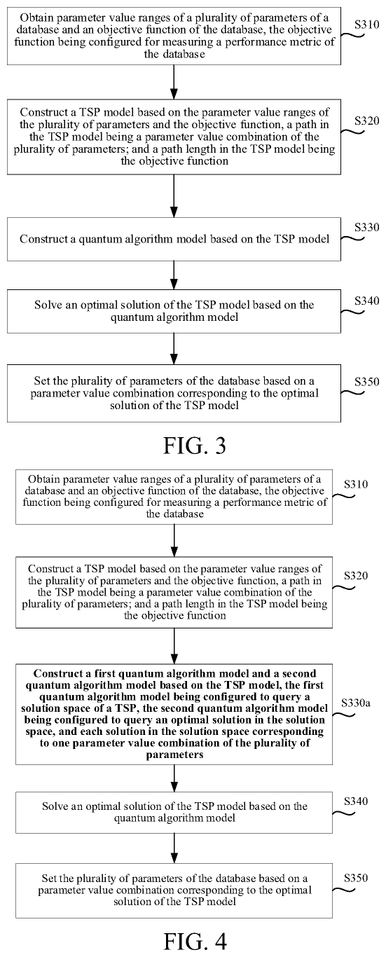

FIG. 3 shows a flowchart of a parameter setting method according to some embodiments. The method is performed by a computer device. As shown in FIG. 3, the method may include operation 310, operation 320, operation 330, operation 340, and operation 350.

Operation 310: Obtain parameter value ranges of a plurality of parameters of a database and an objective function of the database, the objective function being configured for measuring a performance metric of the database.

In some embodiments, the computer device may collect the plurality of parameters from the database to determine the parameter value ranges of the plurality of parameters and obtain the objective function of the database. The objective function is configured for measuring a metric of performance or effectiveness of the database. In an embodiment, the foregoing objective function is a function configured for measuring the performance or effectiveness of the database. For example, the foregoing objective function is a function in which parameter values of the plurality of parameters of the database are used as inputs and the metric of the performance or effectiveness of the database is used as an output. The foregoing database may be an enterprise-level database, a cloud database, or the like.

The plurality of parameters includes a buffer size, a thread pool size, a log size, lock granularity, and the like. Different parameter configurations have different impacts on performance and reliability of a database system.

The foregoing parameter value range refers to a value range of a parameter. The parameter value ranges of the plurality of parameters are limited. For example, a parameter value range of a thread is 1 to 10.

In some embodiments, the computer device may perform normalization on the parameter value ranges of the plurality of parameters, to unify the parameter value ranges of the plurality of parameters to a specified value range.

In a possible implementation, the performing normalization on the parameter value ranges of the plurality of parameters may refer to separately performing normalization on the parameter value range of each parameter, to unify the parameter value range of the parameter to the specified value range. Value ranges of parameter value ranges of different parameters that are subjected to normalization may be the same, or value ranges of parameter value ranges of different parameters that are subjected to normalization may be different.

Operation 320: Construct a TSP model based on the parameter value ranges of the plurality of parameters and the objective function, a path in the TSP model being a parameter value combination of the plurality of parameters; and a path length in the TSP model being the objective function.

In some embodiments, the computer device may construct the TSP model based on the parameter value ranges of the plurality of parameters and the objective function that are obtained in operation 310.

The TSP model refers to a mathematical model of a TSP. A mathematical description of the TSP may be represented based on graph theory. It is assumed that there is a graph G=(V, E), where V is a collection of vertices and represents cities; and E is a collection of edges and represents connections between cities. Each edge (i, j) has a weight w (i, j) representing a distance from a city i to a city j. An objective of the TSP is to find a path with a minimum total distance. The path may pass through each vertex just once and returns to a starting point.

In some embodiments, the path in the foregoing TSP model is the parameter value combination of the plurality of parameters. The parameter value combination is a variable that may be adjusted and optimized. In the TSP model, the parameter value combination may be considered as a path selection of a traveling salesman, that is, determining an order in which the traveling salesman visits each city.

The path length in the TSP model is the objective function. The objective function measures a metric of performance or effectiveness of parameter setting. In the TSP model, the objective function is to find a shortest travel path for the traveling salesman to pass through each city just once and return to a starting city.

That is, the constructing a TSP model based on the parameter value ranges of the plurality of parameters and the objective function is constructing a TSP model in which a parameter value combination of the plurality of parameters is used as a path and the objective function is used as a path length.

Operation 330: Construct a quantum algorithm model based on the TSP model.

In some embodiments, the computer device may construct the quantum algorithm model based on the TSP model constructed in operation 320.

The TSP is an NP-hard problem in combinatorial optimization. Based on a computational model, solving the TSP model may consume a large amount of time and resources. Solving the quantum algorithm model may be completed quickly based on quantum logic and properties of quantum states, such as superposition and entanglement. Compared with a classical computer, a quantum computer can process data at an exponential scale, and process or evaluate performance of a plurality of possible parameter combinations simultaneously based on characteristics of quantum superposition and quantum parallelism, which enhances final efficiency of database query.

The foregoing quantum algorithm model is also referred to as a quantum computing model or a quantum circuit model, and is a mathematical model configured to represent a quantum circuit.

Operation 340: Solve an optimal solution of the TSP model based on the quantum algorithm model.

In some embodiments, the computer device may solve the optimal solution of the TSP model based on the quantum algorithm model constructed in operation 330.

The solving an optimal solution of the TSP model based on the quantum algorithm model may refer to running the foregoing quantum algorithm model, to obtain a running result of the quantum algorithm model. In this way, the optimal solution of the TSP model is obtained.

Operation 350: Set the plurality of parameters of the database based on a parameter value combination corresponding to the optimal solution of the TSP model.

In some embodiments, the computer device may set the plurality of parameters of the database based on the parameter value combination corresponding to the optimal solution solved in operation 340. For example, the computer device may set parameter values in the parameter value combination corresponding to the optimal solution of the TSP model as parameter values of the plurality of parameters of the database.

In conclusion, according to the technical solution provided in some embodiments, the parameter value combination of the plurality of parameters of the database is constructed as the path in the TSP model, and the objective function of the database is constructed as the path length in the TSP model. The quantum algorithm model is constructed based on the TSP model. The optimal solution of the TSP model is solved through quantum computing based on the quantum algorithm model, and the plurality of parameters of the database are correspondingly set, to optimize a performance metric of the database. Compared with computing, quantum computing can process data at an exponential scale, and can process or evaluate performance of a plurality of possible parameter combinations simultaneously. Therefore, according to the solution in some embodiments, a parameter tuning problem of a database can be solved more quickly and efficiently, efficiency and accuracy of parameter setting of the database are ensured, and efficiency and accuracy of database query are enhanced.

Based on the solution according to some embodiments, FIG. 4 shows a flowchart of a parameter setting method according to some embodiments. The method is performed by a computer device. As shown in FIG. 4, operation 330 in the foregoing embodiment shown in FIG. 3 may be implemented as operation 330a.

Operation 330a: Construct a first quantum algorithm model and a second quantum algorithm model based on the TSP model, the first quantum algorithm model being configured to query a solution space of a TSP, and the second quantum algorithm model being configured to query an optimal solution in the solution space.

Each solution in the solution space corresponds to one parameter value combination of the plurality of parameters.

In some embodiments, the computer device may construct, based on the TSP model constructed in operation 320, the first quantum algorithm model configured to query the solution space of the TSP and the second quantum algorithm model configured to query the optimal solution in the solution space. Each solution in the solution space corresponds to one parameter value combination of the plurality of parameters.

The constructing a first quantum algorithm model and a second quantum algorithm model based on the TSP model refers to constructing the first quantum algorithm model configured to query the solution space of the TSP and the second quantum algorithm model configured to query the optimal solution in the solution space.

In some embodiments, the first quantum algorithm model may be an NP-complete problem model such as a Hamiltonian cycle problem model.

In some embodiments, the second quantum algorithm model may be a Grover's algorithm model, or may be a quantum simulation algorithm model.

The quantum computer can process a plurality of possibilities in one computation based on characteristics of qubits, such as superposition and entanglement, which enables the quantum computer to have potential advantages in fields such as search, optimization, and simulation. For an NP problem, the quantum computer can search for a solution space based on quantum parallelism and quantum coherence, to find a solution to the problem. Quantum parallelism allows the quantum computer to process a plurality of possible solutions simultaneously. Quantum coherence allows the quantum computer to use interference effects in a search process, which increases a probability of finding a correct solution.

In quantum computing, a feedback result is obtained by measuring a state of a qubit. Outputs of the quantum computer are results of a series of measured qubits, and these results are represented in a form of probabilities. By operating the same computation for a plurality of times, statistics on a frequency of the measurement results may be collected, and the solution to the problem may be estimated according to the frequency.

Some embodiments provide the technical solution of constructing the quantum algorithm model based on the TSP model. The two quantum algorithm models are constructed. One is configured to query the solution space of the TSP, and the other is configured to query the optimal solution in the solution space. For the TSP, compared with the classical computer, the quantum computer can search the solution space on an exponential scale based on quantum parallelism and quantum coherence and find the optimal solution to the TSP. In this way, a parameter tuning problem is solved more quickly and efficiently.

Based on the solution according to some embodiments, in some embodiments, the foregoing first quantum algorithm model is a Hamiltonian cycle problem model. Each solution in the solution space corresponds to one Hamiltonian cycle in the Hamiltonian cycle problem model.

A quantum existence problem may be mapped to a Hamiltonian cycle existence problem, and a result of quantum computation may be mapped to a solution to a Hamiltonian cycle.

NP-complete problems are reducible to each other, and both the TSP and the Hamiltonian cycle problem are NP-complete problems. The TSP may be reduced to the Hamiltonian problem. If the Hamiltonian cycle problem is solved, the TSP can also be solved. That is, the parameter optimization problem of the database is solved.

Some embodiments provide the selection solution for the first quantum algorithm model, The Hamiltonian cycle problem model, configured to query the solution space of the TSP. One Hamiltonian cycle in the Hamiltonian cycle problem model is mapped to one solution in the solution space, which can further optimize perfection and reliability of the technical solution of the disclosure.

Based on the solution according to some embodiments, in some embodiments, the foregoing second quantum algorithm model is a Grover's algorithm model. Each solution in the solution space corresponds to one qubit state in the Grover's algorithm model.

In some embodiments, a quantum counting algorithm may be configured for accelerating solving of an NP-complete problem. An example of the NP-complete problem is the Hamiltonian cycle problem. A method for determining whether a graph is a Hamiltonian cycle problem is as follows: it is assumed that there is a Hamiltonian cycle. A simple solution to the Hamiltonian cycle problem is to check whether each sequence of vertices is the Hamiltonian cycle. Finding all possible sequences of vertices in the graph may be completed through quantum counting following the Grover's algorithm. The quantum counting algorithm is sufficient to determine whether the Hamiltonian cycle exists.

The Grover's algorithm is a quantum algorithm, and may search for a target item in an unsorted database within O(sqrt(N)) time. The Grover's algorithm may be configured for accelerating solving of the NP problem.

In some embodiments, a solution space of the NP problem may be considered as an unsorted database, and the Grover's algorithm may be configured for searching for a solution in the solution space. Each solution in the solution space is mapped to one parameter item in the database, and an optimal solution in the solution space may be searched by using the Grover's algorithm.

For example, it is assumed that a solution that satisfies some conditions may be searched in a solution space including N elements. If a search algorithm is used, O(N) time is for finding the solution. However, if the Grover's algorithm is used, the solution can be found within O(sqrt(N)) time. For example, it is assumed that a same problem is given, the problem is solved by using the Grover's algorithm through 10,000 computations, but a classical computer may perform 10000\hat{ }2=100000000 computations.

In the solution according to some embodiments, by mapping the foregoing solution space to the unsorted database, the computer device may search for the optimal solution in the solution space by using the Grover's algorithm.

Some embodiments provide the selection solution for the second quantum algorithm model, The Grover's algorithm model. The qubit state in the Grover's algorithm model corresponds to the solution in the solution space. Searching for the optimal solution in the solution space can be accelerated by using the Grover's algorithm, which enhances efficiency of solving a parameter optimization problem.

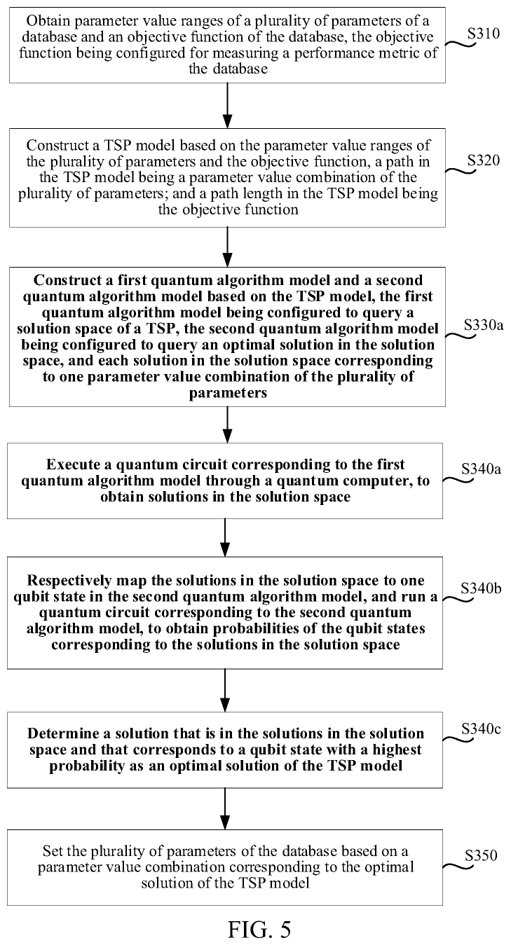

Based on the solution according to some embodiments, FIG. 5 shows a flowchart of a parameter setting method according to yet some embodiments. The method is performed by a computer device. As shown in FIG. 5, operation 340 in the foregoing embodiment shown in FIG. 4 may be implemented as operation 340a, operation 340b, and operation 340c.

Operation 340a: Execute a quantum circuit corresponding to the first quantum algorithm model through a quantum computer, to obtain solutions in the solution space.

In some embodiments, after constructing the first quantum algorithm model and the second quantum algorithm model based on the TSP model in the foregoing operation, the computer device may execute the quantum circuit corresponding to the first quantum algorithm model through the quantum computer, to obtain the solutions in the solution space.

Operation 340b: Respectively map the solutions in the solution space to one qubit state in the second quantum algorithm model, and run a quantum circuit corresponding to the second quantum algorithm model, to obtain probabilities of the qubit states corresponding to the solutions in the solution space.

In some embodiments, after obtaining the solutions in the solution space in operation 340a, the computer device may respectively map the solutions in the solution space to one qubit state in the second quantum algorithm model, and runs the quantum circuit corresponding to the second quantum algorithm model, to obtain the probabilities of the qubit states corresponding to the solutions in the solution space.

The respectively mapping the solutions in the solution space to one qubit state in the second quantum algorithm model refers to respectively mapping each solution in the solution space to one qubit state in the second quantum algorithm model. That is, different solutions in the solution space are respectively mapped to different qubit states in the second quantum algorithm model.

Operation 340c: Determine a solution that is in the solutions in the solution space and that corresponds to a qubit state with a highest probability as the optimal solution of the TSP model.

In some embodiments, after obtaining the probabilities of the qubit states corresponding to the solutions in the solution space in operation 340b, the computer device may determine the solution that is in the solutions in the solution space and that corresponds to the qubit state with the highest probability as the optimal solution of the TSP model.

Optimal parameter setting of the database is one of all possible parameter value combinations. Therefore, a parameter tuning problem of the database may be mapped to a combinatorial optimization problem such as a TSP. An association between the parameter tuning problem and the TSP may be understood in the following manner:

Objective function: in the parameter tuning problem, the objective function measures a metric of performance or effectiveness of parameter setting; and in the TSP, the objective function is to find a shortest travel path for a traveling salesman to pass through each city just once and returns to a starting city.

Parameter setting: in the parameter tuning problem, parameter setting is a variable that may be adjusted and optimized; and in the TSP, parameter setting may be considered as path selection for the traveling salesman, that is, determining an order in which the traveling salesman visits each city.

Constraint condition: in the parameter tuning problem, some constraint conditions (such as a data dependency relationship between parameters and overall performance balance) may exist, which limit value ranges or relationships of parameters; and in the TSP, a constraint condition is that the traveling salesman may pass through each city just once and finally returns to the starting city.

In operation 320 of constructing a TSP model based on the parameter value ranges of the plurality of parameters and the objective function, the parameter optimization problem has been mapped to the TSP. Parameter setting is mapped to the path of the TSP model, the objective function is mapped to the path length, and the constraint condition is mapped to that the path is a loop and the path can pass through each city just once.

In operation 330 of constructing a quantum algorithm model based on the TSP model, the TSP (namely, the parameter optimization problem) is transformed into a quantum computing problem. In operation 340, the optimal solution (namely, optimal parameter setting) to the TSP may be found quickly based on the quantum algorithm model. Finally, the plurality of parameters of the database are set correspondingly.

For example, the quantum algorithm model includes the Hamiltonian cycle problem model and the Grover's algorithm model. First, all possible sequences of vertices in a Hamiltonian graph are searched by using the Hamiltonian cycle problem model, that is, all possible paths of the TSP are searched, that is, all possible parameter value combinations of the plurality of parameters are searched. Then, an optimal sequence of vertices (namely, an optimal parameter value combination) is searched by using the Grover's algorithm model. all possible sequences of vertices (namely, parameter value combinations) are represented as different qubit states; a target qubit state is marked through an oracle; a probability of the target qubit state is increased through a Grover iteration; qubits are measured, and measurement results are represented in a form of probabilities; and a qubit state with a highest probability is mapped to the optimal sequence of vertices (namely, the optimal parameter value combination).

An example in which the second quantum algorithm model is a Grover's algorithm model is used, modeling and feeding back the Grover's algorithm in quantum computing involves the following operations:

S1: Modeling. In the foregoing operation, the parameter tuning problem has been transformed into a form that can be processed by a quantum computer. For the Grover's algorithm, the computer device may represent a search space of a problem as a state of a qubit. Each item in the search space is mapped to a state of one qubit, and includes information about the problem.

S2: Initialization. In the Grover's algorithm, the qubit may be initialized into one uniform superposition state. This may be implemented by setting all qubits in superposition states through a Hadamard gate.

S3: Oracle. An oracle is a key part of the Grover's algorithm, and is configured to mark a target item. In quantum computing, the oracle may be represented as one quantum gate or quantum circuit, which can operate a state of a qubit according to a particular condition of the problem.

S4: Grover iteration. A probability of the target item is increased by using the Grover's algorithm through a plurality of Grover iterations. Each Grover iteration includes three operations: S41: Apply the oracle, S42: Apply a reflection operation, and S43: Repeat.

S41: Apply the oracle. In each iteration of the Grover's algorithm, an oracle operation is first applied. A function of the oracle is to mark the target item, that is, distinguish the target item from other items. The quantum computer can achieve this objective by operating the state of the qubit.

The oracle operates the state of the qubit according to the particular condition of the problem, to distinguish the target item from other items. For example, this may be implemented by applying one particular quantum gate or quantum circuit.

S42: Apply a reflection operation. After S41 of applying the Oracle, S42 of applying a reflection operation is performed next. The reflection operation is a core part of the Grover's algorithm, and helps increase a probability amplitude of the target item. In this way, the target item can be measured more easily.

The reflection operation may be implemented by a quantum gate or quantum circuit that is referred to as Grover reflection. A function of the reflection operation is to reverse the state of the qubit with respect to an average amplitude, to increase the probability amplitude of the target item.

S43: Repeat. After S41 of applying the oracle and S42 of applying a reflection operation, the Grover's algorithm repeats the two operations. A quantity of repetitions depends on a scale of the problem and the probability amplitude of the target item. Usually, the quantity of repetitions is approximately equal to the square root of N, where N denotes a number of a plurality of parameters in a database. By repeatedly applying the oracle and the reflection operation, the probability amplitude of the target item is increased gradually. In this way, the target item is measured more easily.

Through iteration of the three operations, the Grover's algorithm can efficiently search for the target item in the unsorted database. Each iteration helps increase the probability amplitude of the target item, which enhances accuracy and efficiency of finding the target item.

S5: Measurement. At the end of the Grover's algorithm, the qubit may be measured to obtain a final result. A measurement result is represented in a form of a probability, and a result with a highest probability corresponds to the optimal solution of the TSP model.

A measurement manner and method may be implemented by using hardware of the quantum computer, for example, may be completed through quantum measurement gates or measurement circuits. These quantum measurement gate or measurement circuit performs a corresponding operation according to the state of the qubit, to convert state of the qubit into a state of a classical bit.

The foregoing measurement process in S5 may be simply described as the following several operations.

S51: Preparation. Before measurement, it may be ensured that the qubit is in a state. This involves applying a series of quantum operations, for example, applying a Hadamard gate to create one uniform superposition state.

S52: Measurement. In response to the qubit being in the state, a measurement operation is performed. The measurement operation may cause the state of the qubit to collapse into the state of the classical bit, namely, 0 or 1. The measurement result is random, but the probability is proportional to a square of an amplitude of the state of the qubit.

S53: Result. The measurement result is represented in a form of a probability, and the result with the highest probability corresponds to the solution to the problem. For example, in the Grover's algorithm, if the target item is marked correctly, a probability of a measurement result corresponding to the target item is very high.

The measurement process is described by using an example. It is assumed that one qubit is in a superposition state (|0>+|1>) /\sqrt{2}. After measurement, a possible result is 0 or 1, and a probability of each result is 1/2. This means that during repeated measurements, approximately half of results are 0, and the other half of the results are 1.

The measurement operation may cause the state of the qubit to collapse into the state of the classical bit. Therefore, after measurement, information of the qubit is lost. In the Grover's algorithm, a plurality of iterations and measurements are usually performed, to increase the probability amplitude of the target term, which enhances accuracy and efficiency of finding the target term.

With respect to feedback, a result of the Grover's algorithm is usually obtained by running the algorithm for a plurality of times and collecting statistics on a frequency of measurement results. The probability of the target item may be increased by repeatedly running the Grover's algorithm, and a result closer to the optimal solution is finally obtained.

Some embodiments provide the technical solution of solving the optimal solution of the TSP model based on the quantum algorithm model. The optimal solution of the TSP model can be obtained more quickly and efficiently by using the quantum algorithm. The quantum computer executes the quantum circuit of the first quantum algorithm model, to obtain the solutions in the solution space; then respectively maps the solutions in the solution space to the qubit states in the second quantum algorithm model, and runs the quantum circuit of the second quantum algorithm model, to obtain the probabilities of the qubit states corresponding to the solutions in the solution space; and finally, determines the solution that is in the solutions in the solution space and that corresponds to the qubit state with the highest probability as the optimal solution of the TSP model. Subsequently, the plurality of parameters of the database are set based on the parameter value combination corresponding to the optimal solution of the TSP model.

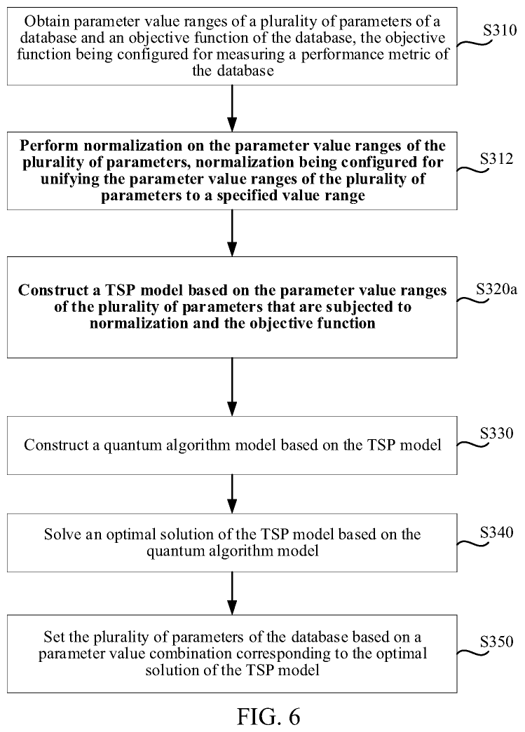

Based on the solution according to some embodiments, FIG. 6 shows a flowchart of a parameter setting method according to some embodiments. The method is performed by a computer device. As shown in FIG. 6, before operation 320, the method may include operation 312.

Operation 312: Perform normalization on the parameter value ranges of the plurality of parameters, normalization being configured for unifying the parameter value ranges of the plurality of parameters to a specified value range.

Operation 320 may be implemented as operation 320a.

Operation 320a: Construct the TSP model based on the parameter value ranges of the plurality of parameters that are subjected to normalization and the objective function.

In some embodiments, the computer device normalizes the plurality of parameters, to make all the parameters fall within one value range; and then, constructs the TSP model based on the parameter value ranges of the plurality of parameters that are subjected to normalization and the objective function.

The constructing the TSP model based on the parameter value ranges of the plurality of parameters that are subjected to normalization and the objective function is constructing a TSP model in which a parameter value combination of the plurality of parameters that are subjected to normalization is used as a path and the objective function is used as a path length.

Some embodiments provide the technical solution of performing normalization on the plurality of parameters before the TSP model is constructed. In addition, the computer device may construct the TSP model based on the parameter value ranges of the plurality of parameters that are subjected to normalization and the objective function. In this way, the parameter value ranges of the plurality of parameters are unified to the specified value range, and subsequent processing is facilitated, which enhances efficiency of solving the optimal solution of the TSP model.

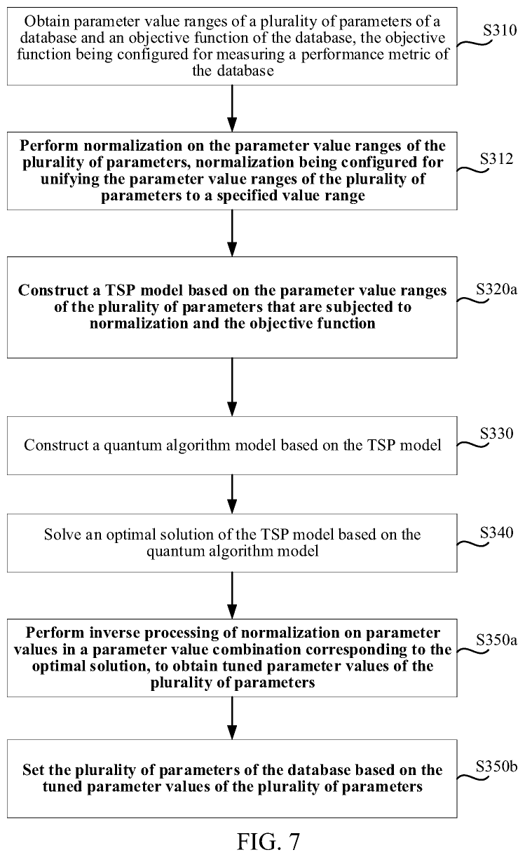

Based on the solution according to some embodiments, FIG. 7 shows a flowchart of a parameter setting method according to some embodiments. The method is performed by a computer device. As shown in FIG. 7, operation 350 may be implemented as operation 350a and operation 350b.

Operation 350a: Perform inverse processing of normalization on parameter values in the parameter value combination corresponding to the optimal solution, to obtain tuned parameter values of the plurality of parameters.

Operation 350b: Set the plurality of parameters of the database based on the tuned parameter values of the plurality of parameters.

In some embodiments, because normalization is performed on the plurality of parameters in the foregoing operation, inverse processing of normalization may be performed on the parameter values in the parameter value combination corresponding to the optimal solution, to obtain the tuned parameter values of the plurality of parameters; and then, the plurality of parameters of the database are set based on the tuned parameter values of the plurality of parameters.

The inverse processing of normalization refers to mapping the parameter values in the parameter value combination to parameter value ranges of corresponding parameters before the inverse processing, to obtain the foregoing tuned parameter values.

For example, the setting, by the computer device, the plurality of parameters of the database based on the tuned parameter values of the plurality of parameters includes, but is not limited to, directly setting the tuned parameter values of the plurality of parameters as the plurality of parameters of the database.

Some embodiments provide the solution of the inverse processing relative to normalization, which facilitates obtaining the tuned parameter values of the plurality of parameters and further setting the plurality of parameters of the database. In this way, efficiency of solving a parameter optimization problem is enhanced, and performance of the database is optimized.

Based on the solution according to some embodiments, in some embodiments, based on the solution according to the embodiment shown in FIG. 3, the plurality of parameters includes a parameter corresponding to a query configuration of the database.

In some embodiments, the computer device may perform a query operation on the database via an API. A query-related parameter in the database may be set for completing the query operation with minimum execution time and resource consumption. Therefore, the plurality of parameters in some embodiments include the parameter corresponding to the query configuration of the database.

Some embodiments provide an applicable scenario of the technical solution of the disclosure, A query scenario of the database. A related parameter is the parameter corresponding to the query configuration of the database. This can further optimize applicability and operability of the technical solution of the disclosure.

Based on the solution according to some embodiments, in some embodiments, the plurality of parameters includes a plurality of the following parameters:
a buffer parameter, a concurrent connection parameter, a query optimization parameter, an index parameter, a log parameter, an internal memory allocation parameter, a disk input/output parameter, and a processor utilization parameter.

In some embodiments, MySQL is used as an example, the plurality of parameters includes a plurality of the following parameters.

Buffer size: a MySQL buffer size refers to a data volume of MySQL buffered in internal memory. Increasing the buffer size can enhance query performance, but occupies more internal memory resources.

Common buffer parameters include: innodb_buffer_pool_size, key_buffer_size, and the like.

Concurrent connections: MySQL concurrent connections refer to connections processed by MySQL simultaneously. Increasing the concurrent connections can enhance concurrent performance, but also occupies more system resources.

Common concurrent connection parameters include max_connections, thread_cache_size, and the like.

Query optimizer: a MySQL query optimizer refers to an algorithm of MySQL that is configured for optimizing a query execution plan. Different query optimizers may have different impacts on query performance.

Common query optimization parameters include: optimizer_switch, join_buffer_size, and the like.

Index: a MySQL index is a data structure configured for accelerating queries. Increasing indexes can enhance query performance, but also occupy more storage space and system resources.

Common index parameters include: innodb_ft_result_cache_limit, innodb_ft_total_cache_size, and the like.

Log: a MySQL log is information configured for recording a MySQL operation. Increasing a log level can enhance a fault investigation capability, but also occupies more storage space and system resources.

Common log parameters include log_error, slow_query_log, and the like.

Internal memory allocation: MySQL internal memory allocation refers to a size of an internal memory block allocated to MySQL in the internal memory. Increasing the size of the allocated internal memory can enhance query performance, but also occupies more internal memory resources.

Common internal memory allocation parameters include: innodb_log_buffer_size, sort_buffer_size, and the like.

Disk input/output (I/O): a MySQL disk I/O refers to a speed at which MySQL reads from/writes to a disk. Optimizing the disk I/O can enhance query performance, but factors such as a disk capacity and a disk read and write speed also may be considered.

Common disk I/O parameters include: innodb_io_capacity, innodb_flush_method, and the like.

CPU utilization: a MySQL CPU utilization refers to efficiency of using a CPU by MySQL. Optimizing the CPU utilization can enhance query performance, but factors such as a quantity of CPU cores and a CPU load also may be considered.

Common CPU utilization parameters include: innodb_thread_concurrency, innodb_spin_wait_delay, and the like.

Some embodiments provide the exemplar solution for the plurality of parameters. Parameter types that can be tuned according to the solution of the disclosure are described, and the application scenario of the solution of the disclosure is clarified, which facilitates solving a parameter tuning problem of MySQL.

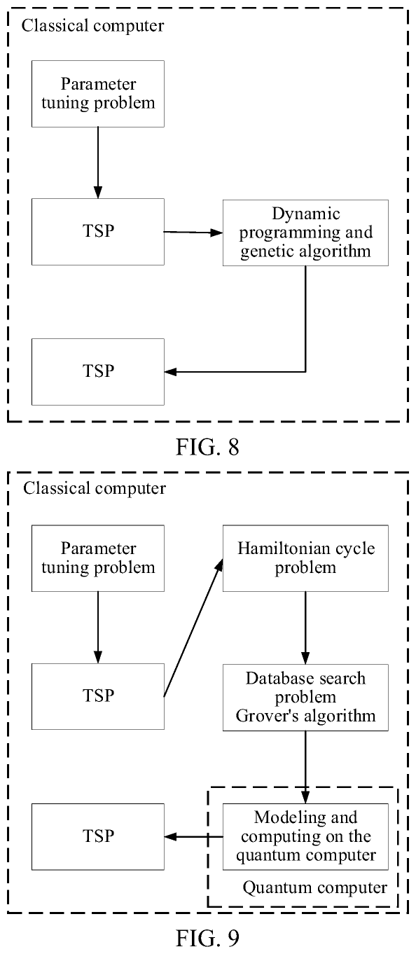

FIG. 8 shows a flowchart of solving a parameter tuning problem based on a classical computer according to some embodiments. As shown in FIG. 8, a computer device can transform a parameter tuning problem into a TSP, and then search for optimal parameter setting by using a TSP algorithm.

Parameter setting may be mapped to a path of a traveling salesman, an objective function is mapped to a length of the travel path, and then a shortest path is usually solved by using the TSP algorithm (such as dynamic programming and a genetic algorithm).

FIG. 9 shows a flowchart of solving a parameter tuning problem based on a quantum computer according to some embodiments. As shown in FIG. 9, first, a parameter tuning problem is transformed into a TSP. Both the TSP and a Hamiltonian cycle problem are NP-complete problems, and NP-complete problems are reducible to each other. Therefore, the TSP may be reduced to the Hamiltonian cycle problem. That is, if the Hamiltonian cycle problem is solved, the TSP can also be solved, that is, the parameter optimization problem is solved. Then, a database search problem Grover's algorithm configured for solving the Hamiltonian cycle problem is constructed. Then, modeling and computation may be performed on the quantum computer by using the Grover's algorithm, to solve the TSP. A solution to the TSP may be used as a solution to the parameter optimization problem, and is configured for optimizing a parameter of a database.

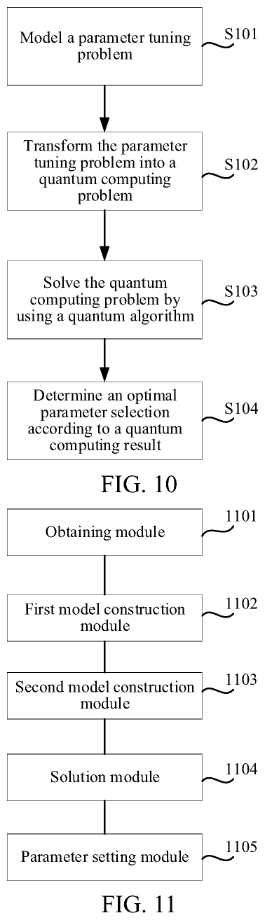

FIG. 10 shows a flowchart of a parameter selection method according to some embodiments, to describes an implementation of the solution of the disclosure. As shown in FIG. 10, the method includes the following operations.

S101: Collect parameters of a database, determine parameter value ranges, and model a parameter tuning problem.

S102: Transform the parameter tuning problem into a quantum computing problem, and Transform the parameter tuning problem into a TSP, and then transform the TSP into the quantum computing problem.

S103: Solve the quantum computing problem by using a quantum algorithm such as a Grover's algorithm and a quantum simulation algorithm.

S104: Determine an optimal parameter selection of the database according to a quantum computing result.

Then, a computer device may apply the optimal parameter selection to a database query configuration, to enhance efficiency and accuracy of query optimization.

In conclusion, in this application, based on characteristics of quantum computing, the parameter tuning problem can be solved more quickly and efficiently, which enhances overall efficiency and accuracy of database query. Compared with the classical computer, the quantum computer can process data at an exponential scale, and process or evaluate performance of a plurality of possible parameter combinations simultaneously based on characteristics of quantum superposition and quantum parallelism, which enhances final efficiency of database query. In addition, the quantum computer can optimize performance of query based on characteristics of quantum entanglement and quantum interference, which enhances accuracy and efficiency of query.

In this application, a parameter problem can be solved more quickly and efficiently, which enhances efficiency and accuracy of query optimization. A system of the disclosure may be applied to various database query optimization scenarios, including an enterprise-level database, a cloud database, big data analysis, and the like. The foregoing database may be a database corresponding to a server. The server may be an independent physical server, or may be a server cluster or distributed system that includes a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

A function of database parameter tuning is to optimize performance and reliability of a database system, to meet different service requirements and user requirements. Parameters in the database system include a buffer size, a thread pool size, a log size, lock granularity, and the like. Different parameter configurations may have different impacts on performance and reliability of the database system. Therefore, selecting an optimal parameter configuration is crucial to the performance and reliability of the database system.

In this application, a latest quantum computing technology is employed, which has strong practical significance for enhancing competitiveness and technical impact of a distributed database.

The quantum computing technology is an emerging computing technology, which can process a large amount of data and complex computational problems in a short time based on principles of quantum mechanics. In terms of database parameter tuning, the quantum computing technology may bring benefits in the following several aspects:

1. Faster parameter tuning: the quantum computing technology can process a large amount of data and complex computational problems in a short time, and complete a parameter tuning process more quickly, whereby tuning efficiency is enhanced.

2. More accurate parameter tuning result: the quantum computing technology can process a more complex computational problem, and analyze a relationship between performance of the database system and a parameter configuration more accurately, whereby accuracy of a tuning result is enhanced.

3. More comprehensive parameter tuning solution: the quantum computing technology can process more data and parameter combinations, and generate a more comprehensive parameter tuning solution, thereby enhancing the tuning effect.

4. More efficient resource utilization: the quantum computing technology can optimize a resource utilization of the database system, including a CPU utilization, an internal memory utilization, a disk utilization, and the like. This can enhance efficiency and a sustainable development capability of the database system.

5. Higher scalability: the quantum computing technology can process data and computational problems at a larger scale, and better meet scalability requirements of the database system, whereby a sustainable development capability of the database system is enhanced.

In conclusion, the quantum computing technology can bring a faster, more accurate, more comprehensive, more efficient, and more scalable parameter tuning solution, which enhances performance and reliability of the database system, and enhances service efficiency and competitiveness of an enterprise.

FIG. 11 shows a block diagram of a parameter setting apparatus according to some embodiments. The apparatus may be configured to perform all or some operations that are in the method shown in FIG. 3, FIG. 4, FIG. 5, FIG. 6, or FIG. 9 and that are performed by a computer device. As shown in FIG. 11, the apparatus includes:
an obtaining module 1101, configured to obtain parameter value ranges of a plurality of parameters of a database and an objective function of the database, the objective function being configured for measuring a performance metric of the database;
a first model construction module 1102, configured to construct a TSP model based on the parameter value ranges of the plurality of parameters and the objective function, a path in the TSP model being a parameter value combination of the plurality of parameters; and a path length in the TSP model being the objective function;
a second model construction module 1103, configured to construct a quantum algorithm model based on the TSP model;
a solution module 1104, configured to solve an optimal solution of the TSP model based on the quantum algorithm model; and
a parameter setting module 1105, configured to set the plurality of parameters of the database based on a parameter value combination corresponding to the optimal solution of the TSP model.

In some embodiments, the second model construction module 1103 is configured to construct a first quantum algorithm model and a second quantum algorithm model based on the TSP model, the first quantum algorithm model being configured to query a solution space of a TSP, the second quantum algorithm model being configured to query an optimal solution in the solution space, and each solution in the solution space corresponding to one parameter value combination of the plurality of parameters.

In some embodiments, the first quantum algorithm model is a Hamiltonian cycle problem model. Each solution in the solution space corresponds to one Hamiltonian cycle in the Hamiltonian cycle problem model.

In some embodiments, the second quantum algorithm model is a Grover's algorithm model. Each solution in the solution space corresponds to one qubit state in the Grover's algorithm model.

In some embodiments, the solution module 1104 is configured to execute a quantum circuit corresponding to the first quantum algorithm model through a quantum computer, to obtain solutions in the solution space; respectively map the solutions in the solution space to one qubit state in the second quantum algorithm model, and run a quantum circuit corresponding to the second quantum algorithm model, to obtain probabilities of the qubit states corresponding to the solutions in the solution space; and determine a solution that is in the solutions in the solution space and that corresponds to a qubit state with a highest probability as the optimal solution of the TSP model.

In some embodiments, the apparatus further includes: a processing module, configured to perform normalization on the parameter value ranges of the plurality of parameters before the first model construction module 1102 constructs the TSP model based on the parameter value ranges of the plurality of parameters and the objective function, normalization being configured for unifying the parameter value ranges of the plurality of parameters to a specified value range.

The first model construction module 1102 is configured to construct the TSP model based on the parameter value ranges of the plurality of parameters that are subjected to normalization and the objective function.

In some embodiments, the parameter setting module 1105 is configured to perform inverse processing of normalization on parameter values in the parameter value combination corresponding to the optimal solution, to obtain tuned parameter values of the plurality of parameters; and set the plurality of parameters of the database based on the tuned parameter values of the plurality of parameters.

In some embodiments, the plurality of parameters includes a parameter corresponding to a query configuration of the database.

In some embodiments, the plurality of parameters includes a plurality of the following parameters: a buffer parameter, a concurrent connection parameter, a query optimization parameter, an index parameter, a log parameter, an internal memory allocation parameter, a disk input/output parameter, and a processor utilization parameter.

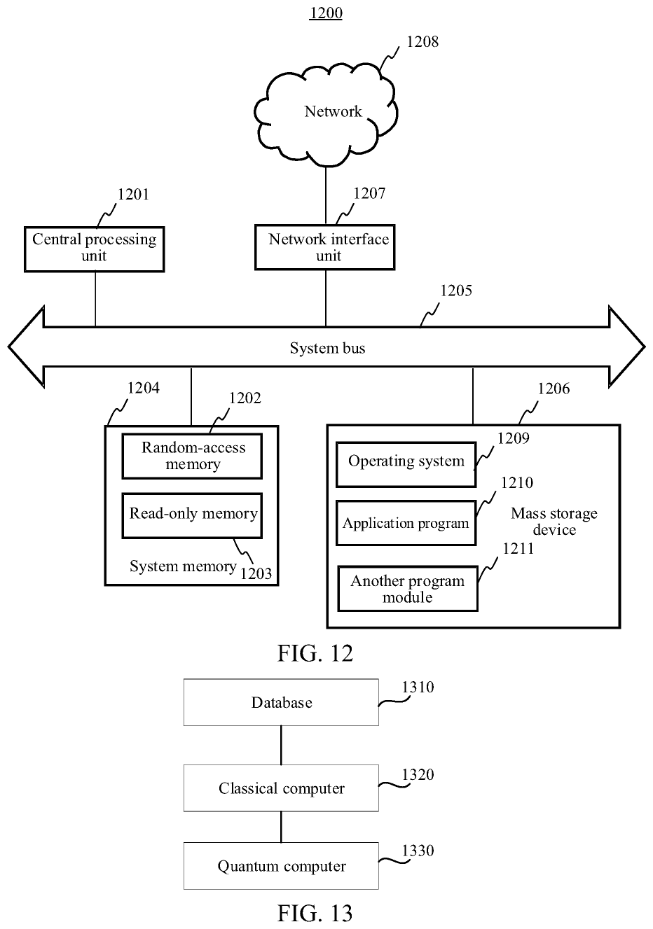

FIG. 12 shows a structural block diagram of a computer device 1200 according to some embodiments. The computer device 1200 includes a CPU 1201, a system memory 1204 including a random-access memory (RAM) 1202 and a read-only memory (ROM) 1203, and a system bus 1205 connecting the system memory 1204 to the CPU 1201. The computer device 1200 further includes a mass storage device 1206 configured to store an operating system 1209, an application program 1210, and another program module 1211.

The mass storage device 1206 is connected to the CPU 1201 through a mass storage controller (not shown) connected to the system bus 1205. The mass storage device 1206 and a computer-readable medium associated with the mass storage device provide non-volatile storage for the computer device 1200. That is, the mass storage device 1206 may include a computer-readable medium (not shown) such as a hard disk or a compact disc read-only memory (CD-ROM) drive.

Generally, the computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The computer storage medium includes RAM, ROM, an erasable programmable ROM (EPROM), an electrically EPROM (EEPROM), flash memory or another solid-state storage technology, a CD-ROM, a digital versatile disc (DVD) or another optical storage, a cassette, a magnetic tape, a disk storage, or another magnetic storage device. A person skilled in art can know that the computer storage medium is not limited to the foregoing several types. The foregoing system memory 1204 and the foregoing mass storage device 1206 may be collectively referred to as a memory.

According to some embodiments, the computer device 1200 may further be connected, over a network such as the Internet, to a remote computer on the network and run. That is, the computer device 1200 may be connected to a network 1208 through a network interface unit 1207 connected to the system bus 1205, or may be connected to another type of network or a remote computer system (not shown) through a network interface unit 1207.

The memory further includes at least one computer program. The at least one computer program is stored in a memory. The CPU 1201 executes the at least one computer program to implement all or some of the operations in the method according to the foregoing embodiments.

In an exemplary embodiment, a chip is further provided. The chip includes a programmable logic circuit and/or program instructions. When running on a computer device, the chip is configured to implement the parameter setting method according to the foregoing aspect.

In an exemplary embodiment, a computer program is further provided. The computer program includes computer instructions. The computer instructions are stored in a computer-readable storage medium. A processor of a computer device reads the computer instructions from the computer-readable storage medium and executes the computer instructions to implement the parameter setting method provided in the foregoing method embodiments.

In an exemplary embodiment, a computer-readable storage medium is further provided. The computer-readable storage medium has a computer program stored herein, and the computer program is loaded and executed by a processor to implement the parameter setting method provided in the foregoing method embodiments.

FIG. 13 shows a schematic structural diagram of a parameter setting system according to some embodiments. As shown in FIG. 13, the system may include a database 1310, a classical computer 1320, and a quantum computer 1330.

The classical computer 1320 is configured to obtain parameter value ranges of a plurality of parameters of the database 1310 and an objective function of the database 1310, the objective function being configured for measuring a performance metric of the database 1310; construct a TSP model based on the parameter value ranges of the plurality of parameters and the objective function, a path in the TSP model being a parameter value combination of the plurality of parameters; and a path length in the TSP model being the objective function; and construct a quantum algorithm model based on the TSP model.

The quantum computer 1330 is configured to solve an optimal solution of the TSP model based on the quantum algorithm model.

The classical computer 1320 is configured to set the plurality of parameters of the database based on a parameter value combination corresponding to the optimal solution of the TSP model.

The foregoing classical computer 1320 may be implemented as the computer 24 in the application scenario shown in FIG. 2. The foregoing quantum computer 1330 may be implemented as the quantum computing device 21, the dilution refrigerator 22, and the control device 23 in the application scenario shown in FIG. 2.

In an exemplary embodiment, a quantum computer is further provided. The quantum computer is configured to solve an optimal solution of a TSP model through a quantum algorithm model. In this way, a classical computer sets a plurality of parameters of a database based on a parameter value combination corresponding to the optimal solution of the TSP model. With respect to the quantum algorithm model, the classical computer obtains parameter value ranges of the plurality of parameters of the database and an objective function of the database, the TSP model is constructed based on the parameter value ranges of the plurality of parameters and the objective function, and the quantum algorithm model is constructed based on the TSP model. The objective function is configured for measuring a performance metric of the database. A path in the TSP model is a parameter value combination of the plurality of parameters; and a path length in the TSP model is the objective function.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A parameter setting method, performed by a computer device, the method comprising:
obtaining parameter value ranges of a plurality of parameters of a database and an objective function to measure a performance metric of the database;
constructing a Traveling Salesman Problem (TSP) model based on the parameter value ranges and the objective function, wherein a path in the TSP model is a parameter value combination of the plurality of parameters and a path length in the TSP model is the objective function;
constructing a quantum algorithm model based on the TSP model;
solving an optimal solution of the TSP model based on the quantum algorithm model; and
setting the plurality of parameters based on a parameter value combination corresponding to the optimal solution of the TSP model.

2. The method according to claim 1, wherein the constructing a quantum algorithm model comprises:
constructing a first quantum algorithm model configured to generate a solution space of the TSP model; and
constructing a second quantum algorithm model configured to identify an optimal solution within the solution space,
wherein each solution in the solution space corresponds to a combination of parameter values for the plurality of parameters.

3. The method according to claim 2, wherein the first quantum algorithm model comprises a Hamiltonian cycle problem model; and
wherein each solution in the solution space corresponds to one Hamiltonian cycle in the Hamiltonian cycle problem model.

4. The method according to claim 2, wherein the second quantum algorithm model comprises a Grover's algorithm model; and
wherein each solution in the solution space corresponds to one qubit state in the Grover's algorithm model.

5. The method according to claim 1, wherein the solving comprises:
executing, on a quantum computer, a quantum circuit corresponding to the first quantum algorithm model, to obtain solutions in the solution space;
mapping each of the solutions in the solution space to a respective qubit state in the second quantum algorithm model;
running a quantum circuit corresponding to the second quantum algorithm model, to obtain probabilities of the qubit states corresponding to the solutions in the solution space; and
determining a solution from the solution space corresponding to a qubit state with the highest probability, as the optimal solution of the TSP model.

6. The method according to claim 1, the method further comprises:
prior to constructing the TSP model, normalizing the parameter value ranges to unify the parameter value ranges to a specified value range; and
wherein the TSP model is constructed based on the normalized parameter value ranges and the objective function.

7. The method according to claim 1, wherein the setting comprises:
applying inverse normalization to the optimal solution to obtain tuned parameter values; and
setting the plurality of parameters of the database based on the tuned parameter values.

8. The method according to claim 1, wherein the plurality of parameters comprise a parameter corresponding to a query configuration of the database.

9. The method according to claim 1, wherein the plurality of parameters comprise at least one of the following parameters:
a buffer parameter, a concurrent connection parameter, a query optimization parameter, an index parameter, a log parameter, an internal memory allocation parameter, a disk input/output parameter, and a processor utilization parameter.

10. The method according to claim 4, wherein executing the Grover's algorithm model comprises:
initializing qubits into a uniform superposition state using a Hadamard gate;
applying an oracle to mark a target qubit state; applying a reflection operation to increase a probability amplitude of the target qubit state; and
repeating the applying the oracle and the applying the reflection operation.

11. A parameter setting apparatus, comprising:
at least one memory configured to store program code; and
at least one processor configured to read the program code and operate as instructed by the program code, the program code comprising:
obtaining code configured to cause at least one of the at least one processor to obtain parameter value ranges of a plurality of parameters of a database and an objective function to measure a performance metric of the database;
TSP code configured to cause at least one of the at least one processor to construct a Traveling Salesman Problem (TSP) model based on the parameter value ranges and the objective function, wherein a path in the TSP model is a parameter value combination of the plurality of parameters and a path length in the TSP model is the objective function;
quantum code configured to cause at least one of the at least one processor to construct a quantum algorithm model based on the TSP model;
solving code configured to cause at least one of the at least one processor to solve an optimal solution of the TSP model based on the quantum algorithm model; and
setting code configured to cause at least one of the at least one processor to set the plurality of parameters based on a parameter value combination corresponding to the optimal solution of the TSP model.

12. The apparatus according to claim 11, wherein the quantum code is further configured to cause at least one of the at least one processor to:
construct a first quantum algorithm model configured to generate a solution space of the TSP model; and
construct a second quantum algorithm model configured to identify an optimal solution within the solution space,
wherein each solution in the solution space corresponds to a combination of parameter values for the plurality of parameters.

13. The apparatus according to claim 12, wherein the first quantum algorithm model comprises a Hamiltonian cycle problem model; and
wherein each solution in the solution space corresponds to one Hamiltonian cycle in the Hamiltonian cycle problem model.

14. The apparatus according to claim 12, wherein the second quantum algorithm model comprises a Grover's algorithm model; and
wherein each solution in the solution space corresponds to one qubit state in the Grover's algorithm model.

15. The apparatus according to claim 11, wherein the solving code is further configured to cause at least one of the at least one processor to:
execute, on a quantum computer, a quantum circuit corresponding to the first quantum algorithm model, to obtain solutions in the solution space;
map each of the solutions in the solution space to a respective qubit state in the second quantum algorithm model;
run a quantum circuit corresponding to the second quantum algorithm model, to obtain probabilities of the qubit states corresponding to the solutions in the solution space; and
determine a solution from the solution space corresponding to a qubit state with the highest probability, as the optimal solution of the TSP model.

16. The apparatus according to claim 11, wherein the program code further comprises:
normalization code configured to cause at least one of the at least one processor to normalize, prior to constructing the TSP model, the parameter value ranges to unify the parameter value ranges to a specified value range; and
wherein the TSP code is further configured to cause at least one of the at least one processor to construct the TSP model based on the normalized parameter value ranges and the objective function.

17. The apparatus according to claim 11, wherein the setting code is further configured to cause at least one of the at least one processor to:
apply inverse normalization to the optimal solution to obtain tuned parameter values; and
set the plurality of parameters of the database based on the tuned parameter values.

18. The apparatus according to claim 11, wherein the plurality of parameters comprise a parameter corresponding to a query configuration of the database.

19. The apparatus according to claim 14, wherein the solving code is further configured to cause at least one of the at least one processor to:
initialize qubits into a uniform superposition state using a Hadamard gate;
apply an oracle to mark a target qubit state;
apply a reflection operation to increase a probability amplitude of the target qubit state; and
repeat the applying the oracle and the applying the reflection operation.

20. A non-transitory computer-readable storage medium, storing computer code which, when executed by at least one processor, causes the at least one processor to at least:
obtain parameter value ranges of a plurality of parameters of a database and an objective function to measure a performance metric of the database;
construct a Traveling Salesman Problem (TSP) model based on the parameter value ranges and the objective function, wherein a path in the TSP model is a parameter value combination of the plurality of parameters and a path length in the TSP model is the objective function;
construct a quantum algorithm model based on the TSP model;
solve an optimal solution of the TSP model based on the quantum algorithm model; and
set the plurality of parameters based on a parameter value combination corresponding to the optimal solution of the TSP model.
